(19) United States
(12) Patent Application Publication
(10) Pub. No.: US 2021/0356185 A1
(43) Pub. Date: Nov. 18, 2021

(54) THREE-TUBE HEAT RECOVERY MULTI-SPLIT AIR CONDITIONING SYSTEM AND CONTROL METHOD FOR THE SAME

(71) Applicants: GD MIDEA HEATING & VENTILATING EQUIPMENT CO., LTD., FOSHAN (CN); MIDEA GROUP CO., LTD., FOSHAN (CN)

(72) Inventors: Kun YANG, FOSHAN (CN); Mingren WANG, FOSHAN (CN)

(21) Appl. No.: 16/625,753

(22) PCT Filed: Dec. 20, 2018
(86) PCT No.: PCT/CN2018/122229

§ 371 Date: Dec. 22, 2019

(30) Foreign Application Priority Data
Jun. 20, 2018 (CN) 201810635734.5

(51) Int. Cl. F25B 47/00; F25B 13/00

(52) U.S. Cl. CPC F25B 47/006; F25B 13/00; F25B 2313/007; F25B 2600/2513; F25B 2313/0253; F25B 2313/0314; F25B 2313/0315; F25B 2313/0233

(57) ABSTRACT

Provided are a three-tube heat recovery multi-split air conditioning system and control method for the same, the system including: an outdoor unit; an indoor unit; a refrigerant distribution device, including a heat exchange assemble, a cooling-heating switching valve, and a low temperature cooling and anti-freezing module; and a controller, configured to acquire an evaporation temperature of the cooling indoor unit and an outdoor ambient temperature when the three-tube heat recovery multi-split air conditioning system operates in a cooling mode or a mixed operation mode, determine whether the evaporation temperature of the cooling indoor unit requires to be adjusted according to the evaporation temperature of the cooling indoor unit and the ambient temperature, and control the low temperature cooling and anti-freezing module to adjust the evaporation temperature of the cooling indoor unit if the evaporation temperature of the indoor unit requires to be adjusted.

### CROSS-REFERENCES TO RELATED APPLICATIONS

The present disclosure is a national phase application of International Application No. PCT/CN2018/122229, filed on Dec. 20, 2018, which claims the priority of Chinese Application No. 201810635734.5, filed in the Chinese Patent Office on Jun. 20, 2018, the entireties of which are herein incorporated by reference.

### FIELD

The present disclosure relates to the field of air conditioners, in particular to a three-tube heat recovery multi-split air conditioning system, a control method for the three-tube heat recovery multi-split air conditioning system, and a non-transitory computer readable storage medium.

### BACKGROUND

A three-tube heat recovery multi-split air conditioning system can operate in a cooling mode and in a heating mode at the same time. When a part of or the whole outdoor heat exchangers of the multi-split air conditioning system act as evaporators, a low pressure saturation temperature of the system may be lower than an outdoor ambient temperature, and a liquid refrigerant in the outdoor heat exchangers can be ensured to absorb heat. However, if the outdoor ambient temperature is lower than a temperature (for example, below 5° C.), the low pressure saturation temperature of the multi-split air conditioning system will be lower than the freezing point of water. In this case, if the system has an indoor cooling requirement, then a temperature of the refrigerant in a coil tube of a cooling indoor unit would be lower than the freezing point because the temperature of the refrigerant in the coil tube of the cooling indoor unit is approximate to the low pressure saturation temperature of the system; the coil tube and a fin would be frosted; the indoor unit frequently enters an anti-freezing protection mode, thus affecting the comfort of the cooling indoor unit, and having the possibility of blowing condensed water and freezing an indoor unit tube.

### SUMMARY

The embodiments of the present disclosure are to solve at least one of the problems in the related art to a certain extent. Therefore, the present disclosure provides a three-tube heat recovery multi-split air conditioning system. The system can adjust an evaporation temperature of a cooling indoor unit via a low temperature cooling and anti-freezing module, and an indoor cooling requirement under a low temperature can be effectively satisfied, thus preventing the indoor unit from being frozen, and ensuring the reliability and comfort of the system.

The present disclosure further provides a control method for the three-tube heat recovery multi-split air conditioning system.

The present disclosure further provides a non-transitory computer readable storage medium.

In a first aspect, an embodiment of the present disclosure provides a three-tube heat recovery multi-split air conditioning system, including: an outdoor unit, including at least one compressor, a low pressure liquid storage tank and an outdoor heat exchanger; an indoor unit, including an indoor heat exchanger; a refrigerant distribution device, having one side connected to the outdoor unit via a high pressure liquid tube, a low pressure air tube and a high pressure air tube, and the other side connected to the indoor unit, and including a heat exchange assemble, a cooling-heating switching valve, and a low temperature cooling and anti-freezing module, and the heat exchange assembly includes a first flow channel and a second flow channel; a first end of the low temperature cooling and anti-freezing module is connected to the low pressure air tube; a second end of the low temperature cooling and anti-freezing module is connected to the second heat exchange flow channel of the heat exchange assembly; and a third end of the low temperature cooling and anti-freezing module is connected to the cooling-heating switching valve; and a controller, configured to acquire an evaporation temperature of the cooling indoor unit and an outdoor ambient temperature when the three-tube heat recovery multi-split air conditioning system operates in a cooling mode or a mixed operation mode, determine whether the evaporation temperature of the cooling indoor unit requires to be adjusted according to the evaporation temperature of the cooling indoor unit and the outdoor ambient temperature, and control the low temperature cooling and anti-freezing module to generate an intermediate pressure between the second end of the low temperature cooling and anti-freezing module and the low pressure air tube to adjust the evaporation temperature of the cooling indoor unit if the evaporation temperature of the indoor unit requires to be adjusted.

In the three-tube heat recovery multi-split air conditioning system according to the embodiment of the present disclosure, the controller is configured to acquire an evaporation temperature of the cooling indoor unit and an outdoor ambient temperature when the three-tube heat recovery multi-split air conditioning system operates in a cooling mode or a mixed operation mode, determine whether the evaporation temperature of the cooling indoor unit requires to be adjusted according to the evaporation temperature of the cooling indoor unit and the ambient temperature, and control the low temperature cooling and anti-freezing module to generate an intermediate pressure between the second end of the low temperature cooling and anti-freezing module and the low pressure air tube to adjust the evaporation temperature of the cooling indoor unit if the evaporation temperature of the indoor unit requires to be adjusted. Therefore, the system can adjust the evaporation temperature of the cooling indoor unit via the low temperature cooling and anti-freezing module, and an indoor cooling requirement under a low temperature can be effectively satisfied, thus preventing the indoor unit from being frozen, and ensuring the reliability and comfort of the system.

In a second aspect, an embodiment of the present disclosure provides a control method for the three-tube heat recovery multi-split air conditioning system, including: acquiring an evaporation temperature of the cooling indoor unit and an outdoor ambient temperature; determining whether the evaporation temperature of the cooling indoor unit requires to be adjusted according to the evaporation temperature of the cooling indoor unit and the outdoor ambient temperature; and controlling the low temperature cooling and anti-freezing module to generate an intermediate pressure between the second end of the low temperature cooling and anti-freezing module and the low pressure air tube to adjust the evaporation temperature of the cooling indoor unit if the evaporation temperature of the cooling indoor unit requires to be adjusted.

In the control method for the three-tube heat recovery multi-split air conditioning system according to the embodiment of the present disclosure, first, an evaporation temperature of the cooling indoor unit and an outdoor ambient temperature are acquired; then, whether the evaporation temperature of the cooling indoor unit requires to be adjusted is determined according to the evaporation temperature of the cooling indoor unit and the outdoor ambient temperature; and if the evaporation temperature of the cooling indoor unit requires to be adjusted, then the low temperature cooling and anti-freezing module is controlled to generate an intermediate pressure between the second end of the low temperature cooling and anti-freezing module and the low pressure air tube to adjust the evaporation temperature of the cooling indoor unit. Therefore, the method can adjust the evaporation temperature of the cooling indoor unit via the low temperature cooling and anti-freezing module, and an indoor cooling requirement under a low temperature can be effectively satisfied, thus preventing the indoor unit from being frozen, and ensuring the reliability and comfort of the system.

In a third aspect, an embodiment of the present disclosure provides a non-transitory computer readable storage medium having stored therein a computer program that, when executed by a processor, causes the processor to realize the control method as described in the second aspect of the present disclosure.

In the non-transitory computer readable storage medium according to the embodiment of the present disclosure, first, an evaporation temperature of the cooling indoor unit and an outdoor ambient temperature are acquired; then, whether the evaporation temperature of the cooling indoor unit requires to be adjusted is determined according to the evaporation temperature of the cooling indoor unit and the outdoor ambient temperature; and if the evaporation temperature of the cooling indoor unit requires to be adjusted, then the low temperature cooling and anti-freezing module is controlled to generate an intermediate pressure between the second end of the low temperature cooling and anti-freezing module and the low pressure air tube to adjust the evaporation temperature of the cooling indoor unit, and an indoor cooling requirement under a low temperature can be effectively satisfied, thus preventing the indoor unit from being frozen, and ensuring the reliability and comfort of the system.

### BRIEF DESCRIPTION OF THE DRAWINGS

Embodiments of the present disclosure will become apparent and easy to understand from the descriptions of the embodiments hereafter in combination with the drawings, and

FIG. 1 is a structural schematic view of the three-tube heat recovery multi-split air conditioning system according to one embodiment of the present disclosure;

FIG. 2 is a structural schematic view of the three-tube heat recovery multi-split air conditioning system according to another embodiment of the present disclosure;

FIG. 3 is a schematic diagram how to adjust and determine the evaporation temperature of the cooling indoor unit according to one embodiment of the present disclosure;

FIG. 4 is a schematic diagram how to adjust the opening degree of the throttle valve according to one embodiment of the present disclosure; and

FIG. 5 is a flow chart of the control method for the three-tube heat recovery multi-split air conditioning system according to one embodiment of the present disclosure.

### DETAILED DESCRIPTION OF THE DISCLOSURE

The embodiments of the present disclosure will be described in detail hereafter, and the examples of the embodiments are shown in the drawings, and the same or similar signs from beginning to end denote the same or similar elements or the elements having the same or similar functions. The embodiments described below with reference to the drawings are for illustration only, and are intended to explain the present disclosure, but not to limit the present disclosure.

The three-tube heat recovery multi-split air conditioning system, the control method for the three-tube heat recovery multi-split air conditioning system and the non-transitory computer readable storage medium provided according to the embodiments of the present disclosure will be described hereafter with reference to the drawings.

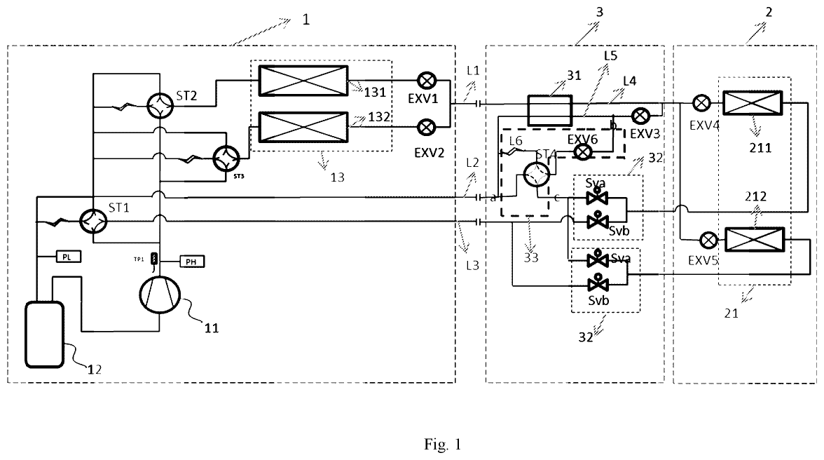

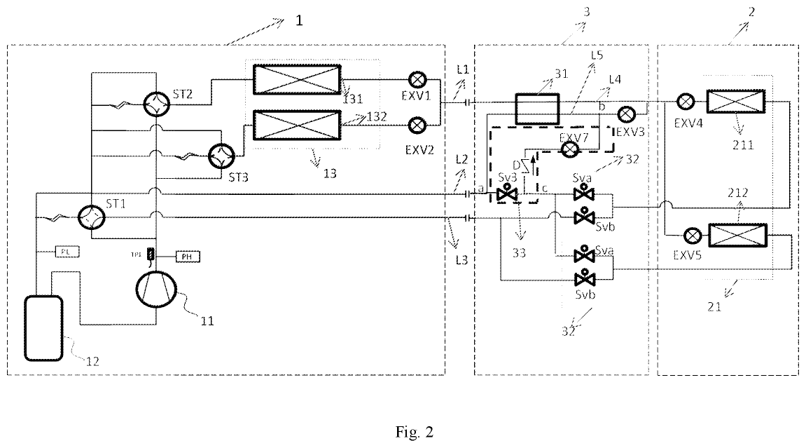

FIG. 1-2 are structural schematic views of the three-tube heat recovery multi-split air conditioning system according to one embodiment of the present disclosure. As shown in FIG. 1-2, the system includes an outdoor unit 1, an indoor unit 2, a refrigerant distribution device 3 and a controller (not shown in the figure),

The outdoor unit 1 includes at least one compressor 11, a low pressure liquid storage tank 12, and an outdoor heat exchanger 13; the indoor unit 2 includes an indoor heat exchanger 21; an exhaust end of the compressor 11 is connected to the outdoor heat exchanger 13 and the indoor heat exchanger 21 respectively; a suction end of the compressor 11 is connected to one end of the low pressure liquid storage tank 12; and the other end of the low pressure liquid storage tank 12 is connected to the outdoor heat exchanger 13; One side of the refrigerant distribution device 3 is connected to the outdoor unit 1 via a high pressure liquid tube L1, a low pressure air tube L2 and a high pressure air tube L3, and the other side of the refrigerant distribution device 3 is connected to the indoor unit 2; the refrigerant distribution device 3 includes a heat exchange assemble 31, a cooling-heating switching valve 32, and a low temperature cooling and anti-freezing module 33, and the heat exchange assembly 31 includes a first flow channel L4 and a second flow channel L5; a first end a of the low temperature cooling and anti-freezing module 33 is connected to the low pressure air tube L2; a second end b of the low temperature cooling and anti-freezing module 33 is connected to the second heat exchange flow channel L5 of the heat exchange assembly 31; and a third end c of the low temperature cooling and anti-freezing module 33 is connected to the cooling-heating switching valve 32. The controller is configured to acquire an evaporation temperature of the cooling indoor unit and an outdoor ambient temperature when the three-tube heat recovery multi-split air conditioning system operates in a cooling mode or a mixed operation mode, determine whether the evaporation temperature of the cooling indoor unit requires to be adjusted according to the evaporation temperature of the cooling indoor unit and the outdoor ambient temperature, and control the low temperature cooling and anti-freezing module 33 to generate an intermediate pressure between the third end c of the low temperature cooling and anti-freezing module and the low pressure air tube L2 to adjust the evaporation temperature of the cooling indoor unit if the evaporation temperature of the indoor unit requires to be adjusted.

As shown in FIG. 1-2, one end of the first flow channel L4 is connected to the outdoor heat exchanger 13 via the high pressure liquid tube L1, and the other end of the first flow channel L4 is connected to the indoor unit 2; one end of the second flow channel L5 is connected to the low pressure liquid storage tank 12 via the low pressure air tube L2, and the other end of the second flow channel L5 is connected to the other end of the first heat exchange flow channel L4. The indoor heat exchanger 21 includes an evaporator 211 and a condenser 212; the number of the cooling-heating switching valve 32 is at least one, for example two as shown in FIG. 1-2; each cooling-heating switching valve 32 includes a first electromagnetic valve Sva, and a second electromagnetic valve Svb, and one end of the first electromagnetic valve Sva is connected to the third end c of the low temperature cooling and anti-freezing module; one end of the second electromagnetic valve Svb is connected to the high pressure air tube L3; and the other ends of the first electromagnetic valve Sva and the second electromagnetic valve Svb in each cooling-heating switching valve are correspondingly connected to the evaporator or the condenser.

In one embodiment, as shown in FIG. 1-2, the outdoor unit 1 may further include four-way valves ST1-ST3 and throttle valves EXV1-EXV2; the outdoor heat exchanger 13 includes a first outdoor heat exchanger 131 and a second outdoor heat exchanger 132; the connection modes between the outdoor unit 1 and various elements are as shown in FIG. 1-2; one end of the first outdoor heat exchanger 131 is connected to one end of the low pressure liquid storage tank 12 via the four-way valves ST2 and ST1, and the other end of the first outdoor heat exchanger 131 is connected to one end of the throttle valve EXV1; the other end of the throttle valve EXV1 is connected to the high pressure liquid tube L1; one end of the second outdoor heat exchanger 132 is connected to one end of the low pressure liquid storage tank 12 via the four-way valve ST3, and the other end of the second outdoor heat exchanger is connected to one end of the throttle valve EXV2; the other end of the throttle valve EXV2 is connected to the high pressure liquid tube L2; the other end of the low pressure liquid storage tank 12 is connection to the suction end of the compressor 11; the suction end of the compressor 11 is connected to one end of the first heat exchanger 131 via the four-way valve ST2, is connected to one end of the second heat exchanger 132 via the four-way valve ST3, and is connected to the high pressure air tube L3 via the four-way valve ST1. In order to facilitate understanding, the connection modes between various elements can directly refer to FIGS. 1-2, and will not be repeated here. The throttle valve EXV3 is disposed on the second heat exchange flow channel L5 of the heat exchange assembly 31 in the refrigerant distribution device 3; the first heat exchange flow channel L4 of the heat exchange assembly 31 is a primary heat exchange flow channel, and the second heat exchange flow channel L5 is a secondary heat exchange flow channel. The indoor unit 2 may further include throttle valves EXV4 and EXV5. The evaporator 211 acts as a cooling indoor unit, and the condenser 212 acts as a heating indoor unit. Generally, the first electromagnetic valve Sva is a cooling electromagnetic valve, and the second electromagnetic valve Svb is a heating electromagnetic valve; when the indoor unit correspondingly connected to the cooling-heating switching valve operates in the cooling mode, then the first electromagnetic valve Sva is controlled to open, and the second electromagnetic valve Svb is controlled to close; and when the indoor unit correspondingly connected to the cooling-heating switching valve operates in the heating mode, then the first electromagnetic valve Sva is controlled to close, and the second electromagnetic valve Svb is controlled to open.

A high temperature high pressure refrigerant at an outlet of the compressor 11 flows to the refrigerant distribution device 3 via the four-way valve ST1, enters the condenser 212, and releases heat into a room; the refrigerant is cooled to low temperature high pressure liquid; a part of the refrigerant flows to the outdoor heat exchanger 13 for evaporation, and the other part flows to the evaporator 211 for evaporation; the evaporated gaseous refrigerant of the evaporator 211 and the gaseous refrigerant of the outdoor heat exchanger converge at the outdoor unit, and then return to the compressor 11. The indoor unit and the outdoor evaporator are arranged in parallel, and the evaporation temperatures of the two are close. When the ambient temperature is low (for example, below 5° C.), in order to ensure the evaporator 211 to absorb heat, the evaporation temperature is lower than the freezing point.

Therefore, in the present disclosure, the refrigerant distribution device 3 is internally provided with a low temperature cooling and anti-freezing module 33; the module is disposed on the low pressure air tube L2; a first end of the module is in communication with the low pressure air tube L2; a second end of the module is disposed on the secondary heat exchange flow channel of the heat exchange assembly 31; and a third end of the module is disposed in front of the cooling-heating switching valve. When the three-tube heat recovery multi-split air conditioning system operates in the cooling mode or the mixed operation mode, the controller acquires an evaporation temperature of the cooling indoor unit and an outdoor ambient temperature, determine whether the evaporation temperature of the cooling indoor unit requires to be adjusted according to the evaporation temperature of the cooling indoor unit and the outdoor ambient temperature; for example, if the evaporation temperature of the cooling indoor unit is lower than 1° C., and the outdoor ambient temperature is lower than 8° C., then the controller can determine that the evaporation temperature of the cooling indoor unit requires to be adjusted. If the evaporation temperature of the cooling indoor unit requires to be adjusted, the controller controls the low temperature cooling and anti-freezing module 33 to generate an intermediate pressure between the third end c of the low temperature cooling and anti-freezing module 33 and the low pressure air tube L2; the evaporation temperature of the cooling indoor unit is positively correlated with pressure, and therefore, the controller can adjust the evaporation temperature of the cooling indoor unit by adjusting a pressure difference between the third end c of the low temperature cooling and anti-freezing module 33 and the low pressure air tube L2; for example, if the evaporation temperature is low, then the pressure difference between the third end c of the low temperature cooling and anti-freezing module 33 and the low pressure air tube L2 can be improved; the pressure on the low pressure air tube L2 side keeps unchanged, and therefore, the improvement of the pressure difference can improve the pressure of the third end c of the low temperature cooling and anti-freezing module 33, and the evaporation pressure of the evaporator can be improved, and the evaporation temperature can be accordingly improved. The system can adjust the evaporation temperature of the cooling indoor unit via the low temperature cooling and anti-freezing module, and an indoor cooling requirement under a low temperature can be effectively satisfied, thus preventing the indoor unit from being frozen, and ensuring the reliability and comfort of the system.

In the present disclosure, the throttle valve can be an electronic expansion valve, an electromagnetic valve or a combination of the electronic expansion valve and the electromagnetic valve.

According to an embodiment of the present disclosure, when the three-tube heat recovery multi-split air conditioning system has an indoor cooling requirement, the system operates in the cooling mode or the mixed operation mode, the evaporation temperature of the cooling indoor unit is less than or equal to a first preset temperature T1 for a first preset time t1, and the outdoor ambient temperature is less than or equal to a third preset temperature T, the controller determines that the evaporation temperature of the cooling indoor unit requires to be adjusted; and when the three-tube heat recovery multi-split air conditioning system operates in the heating mode, the outdoor ambient temperature is greater than the third preset temperature T3, or the evaporation temperature of the cooling indoor unit is greater than the first preset temperature T1 and anti-freezing protection does not start in the cooling indoor unit within the first preset time t1, the controller determines that the evaporation temperature of the cooling indoor unit does not require to be adjusted, and the third preset temperature T3 is greater than the first preset temperature T1.

In the present disclosure, the first preset temperature T1, the third preset temperature T3 and the first preset time can be preset according to practical situations, for example, T1 can be 1° C., T3 can be 8° C., and t1 can be 5 min.

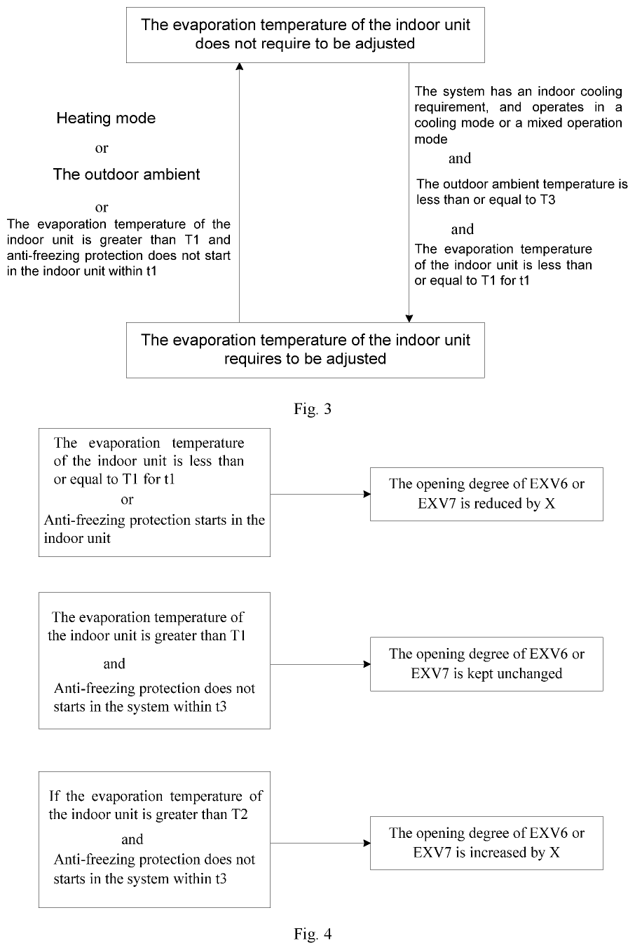

In one embodiment, as shown in FIG. 3, if the three-tube heat recovery multi-split air conditioning system has an indoor cooling requirement, the system operates in the cooling mode or the mixed operation mode, the evaporation temperature of the cooling indoor unit is less than or equal to T1 for t1, and the outdoor ambient temperature is less than or equal to T3, then the controller can determine that the evaporation temperature of the cooling indoor unit requires to be adjusted; and if the three-tube heat recovery multi-split air conditioning system operates in the heating mode, the outdoor ambient temperature is greater than T3, or the evaporation temperature of the cooling indoor unit is greater than T1 and anti-freezing protection does not start in the cooling indoor unit within t1, then the controller can determine that the evaporation temperature of the cooling indoor unit does not require to be adjusted, and in the three-tube heat recovery multi-split air conditioning system, if the temperature of the heat exchanger of the cooling indoor unit is lower than a temperature (generally −5° C.), then the cooling indoor unit will automatically start anti-freezing protection, to prevent the heat exchanger of the cooling indoor unit is frosted and frozen for a long time, which may damage the heat exchanger. The determination period of the controller can be 10-15 min. In other words, the controller can determine one time every 10-15 min whether the evaporation temperature of the cooling indoor unit requires to be adjusted.

As an example, as shown in FIG. 1, the low temperature cooling and anti-freezing module 33 may include a first four-way valve ST4, and a first throttle valve EXV6, and a first end of the first four-way valve ST4 is connected to the low pressure air tube L2, a second end of the first four-way valve ST4 is connected to one end of the first electromagnetic valve Sva, and a third end of the first four-way valve ST4 is connected to the low pressure air tube L2 via a capillary tube L6; one end of the first throttle valve EXV6 is connected to a fourth end of the first four-way valve ST4, and the other end of the first throttle valve EXV6 is connected to the second heat exchange flow channel L5 of the heat exchange assembly 31.

The controller is further configured to: control the first end of the first four-way valve ST4 to communicate with the second end of the first four-way valve ST4 if the evaporation temperature of the cooling indoor unit does not require to be adjusted; and control the second end of the first four-way valve ST4 to communicate with the fourth end of the first four-way valve ST4 if the evaporation temperature of the cooling indoor unit requires to be adjusted.

In one embodiment, as shown in FIG. 1, if the evaporation temperature of the cooling indoor unit does not require to be adjusted, the controller controls the first end of ST4 to communicate with the second end of ST4 and controls EXV6 to completely open, and the low temperature cooling and anti-freezing module 33 does not operate at all. The high temperature high pressure refrigerant discharged by the compressor is delivered to the condenser 212 for condensation via the high pressure air tube L3 and Svb; the generated low temperature high pressure liquid refrigerant is returned to the refrigerant distribution device 3; a part of the liquid refrigerant is delivered to the evaporator 211 for evaporation, and the generated low pressure steam is returned to the outdoor unit 1 via Sva, ST4 and the low pressure air tube L2; the other part of the liquid refrigerant is returned to the outdoor unit 1 via the high pressure liquid tube L1, is throttled by EXV1 and EXV2, is evaporated in the outdoor heat exchanger to be a gaseous refrigerant, converges with the low pressure gaseous refrigerant returned from the low pressure air tube, and finally is returned to the suction end of the compressor 11.

If the evaporation temperature of the cooling indoor unit requires to be adjusted, EXV3 is completely opened, and the controller controls ST4 to change direction to enable the second end to communicate with the fourth end; the high temperature high pressure refrigerant discharged by the compressor 11 is delivered to the condenser 212 for condensation via the high pressure air tube L3 and Svb; the generated low temperature high pressure liquid refrigerant is returned to the refrigerant distribution device 3; a part of the liquid refrigerant is returned to the outdoor unit 1 via the high pressure liquid tube L1, is throttled by EXV1 and EXV2, is evaporated in the outdoor heat exchanger to be a gaseous refrigerant, converges with the low pressure gaseous refrigerant returned from the low pressure air tube, and finally is returned to the suction end of the compressor 11; the other part is throttled by EXV4 to be an intermediate pressure liquid refrigerant; the intermediate pressure liquid refrigerant is evaporated by the evaporator 211; the generated intermediate pressure gaseous refrigerant is throttled by ST4 and EXV6, then flows to the second heat exchange flow channel L5 of the heat exchange assembly 31 and the low pressure air tube L2, and is finally returned to the outdoor unit 1. It can be understood that if the evaporation temperature of the cooling indoor unit requires to be adjusted, the throttling of EXV6 can generate an intermediate pressure between EXV6 and the low pressure air tube L2; the pressure difference between EXV6 and the low pressure air tube L2 can be changed by changing the opening degree of EXV6, and the evaporation temperature of the cooling indoor unit can be changed to effectively satisfy the indoor cooling requirement under a low temperature, thus preventing the indoor unit from being frozen, and ensuring the reliability and comfort of the system.

As another example, as shown in FIG. 2, the low temperature cooling and anti-freezing module 33 may further include a third electromagnetic valve Sv3, a one-way valve D, and a second throttle valve EXV7, and one end of the third electromagnetic valve Sv3 is connected to the low pressure air tube L2, and the other end of the third electromagnetic valve Sv3 is connected to one end of the first electromagnetic valve Sva; one end of the one-way valve D is connected to Sv3 the other end of the third electromagnetic valve Sv3; one end of the second throttle valve EXV7 is connected to the other end of the one-way valve D, and the other end of the second throttle valve EXV7 is connected to the second heat exchange flow channel L5 of the heat exchange assembly 31.

Further, the controller can be further configured to: control the third electromagnetic valve Sv3 to open if the evaporation temperature of the cooling indoor unit does not require to be adjusted; and control the third electromagnetic valve Sv3 to close if the evaporation temperature of the cooling indoor unit requires to be adjusted.

In one embodiment, as shown in FIG. 2, the flow direction of the one-way valve D is as shown by the arrow in FIG. 2; if the evaporation temperature of the cooling indoor unit does not require to be adjusted, the controller controls Sv3 to open and controls EXV7 to completely open, and the low temperature cooling and anti-freezing module 33 does not operate at all. The high temperature high pressure refrigerant discharged by the compressor 11 is delivered to the condenser 212 for condensation via the high pressure air tube L3 and Svb; the generated low temperature high pressure liquid refrigerant is returned to the refrigerant distribution device 3; a part of the liquid refrigerant is delivered to the evaporator 211 for evaporation, and the generated low pressure steam is returned to the outdoor unit 1 via Sva, Sv3 and the low pressure air tube L2; a part of the liquid refrigerant is returned to the outdoor unit 1 via the high pressure liquid tube L1, is throttled by EXV1 and EXV2, is evaporated in the outdoor heat exchanger to be a gaseous refrigerant, converges with the low pressure gaseous refrigerant returned from the low pressure air tube, and finally is returned to the suction end of the compressor 11.

If the evaporation temperature of the cooling indoor unit requires to be adjusted, EXV3 is completely opened, and the controller controls Sv3 to close; the high temperature high pressure refrigerant discharged by the compressor 11 is delivered to the condenser 212 for condensation via the high pressure air tube L3 and Svb; the generated low temperature high pressure liquid refrigerant is returned to the refrigerant distribution device 3; a part of the liquid refrigerant is returned to the outdoor unit 1 via the high pressure liquid tube L1, is throttled by EXV1 and EXV2, is evaporated in the outdoor heat exchanger to be a gaseous refrigerant, converges with the low pressure gaseous refrigerant returned from the low pressure air tube, and finally is returned to the suction end of the compressor 11; the other part is throttled by EXV4 to be an intermediate pressure liquid refrigerant; the intermediate pressure liquid refrigerant is evaporated by the evaporator 211; the generated intermediate pressure gaseous refrigerant is throttled by the one-way valve D and EXV7, then flows to the second heat exchange flow channel L5 of the heat exchange assembly 31 and the low pressure air tube L2, and is finally returned to the outdoor unit 1. It can be understood that if the evaporation temperature of the cooling indoor unit requires to be adjusted, the throttling of EXV7 can generate an intermediate pressure between EXV7 and the low pressure air tube L2; the pressure difference between EXV7 and the low pressure air tube L2 can be changed by changing the opening degree of EXV7, and the evaporation temperature of the cooling indoor unit can be changed to effectively satisfy the indoor cooling requirement under a low temperature, thus preventing the indoor unit from being frozen, and ensuring the reliability and comfort of the system.

According to one embodiment of the present disclosure, in the system as shown in FIG. 1, the controller is further configured to: acquire an evaporation temperature of the cooling indoor unit if the evaporation temperature of the cooling indoor unit requires to be adjusted; reduce an opening degree of the first throttle valve EXV6 by a first preset opening degree X if the evaporation temperature of the cooling indoor unit is less than or equal to the first preset temperature T1 for the first preset time t1, or anti-freezing protection starts in the indoor unit; keep the opening degree of the first throttle valve EXV6 unchanged if the evaporation temperature of the cooling indoor unit is greater than the first preset temperature T1 and anti-freezing protection does not start in the indoor unit; and increase the opening degree of the first throttle valve EXV6 by the first preset opening degree X if the evaporation temperature of the cooling indoor unit is greater than a second preset temperature T2 and anti-freezing protection does not start in the indoor unit within a second preset time t2, and the first preset temperature T1 is less than the second preset temperature T2.

According to one embodiment of the present disclosure, in the system as shown in FIG. 2, the controller is further configured to: acquire an evaporation temperature of the cooling indoor unit if the evaporation temperature of the cooling indoor unit requires to be adjusted; reduce an opening degree of the second throttle valve EXV7 by the first preset opening degree X if the evaporation temperature of the cooling indoor unit is less than or equal to the first preset temperature T1 for the first preset time t1, or anti-freezing protection starts in the indoor unit; keep the opening degree of the second throttle valve EXV7 unchanged if the evaporation temperature of the cooling indoor unit is greater than the first preset temperature T1 and anti-freezing protection does not start in the indoor unit; and increase the opening degree of the second throttle valve EXV7 by the first preset opening degree X if the evaporation temperature of the cooling indoor unit is greater than the second preset temperature T2 and anti-freezing protection does not start in the indoor unit within the second preset time t2. The first preset opening degree X can be preset according to practical situations.

In the present disclosure, the first preset temperature T1, the second preset temperature T2, the first preset time t1 and the second preset time t2 can be preset according to practical situations, for example, T1 can be 1° C., T2 can be 12° C., t1 can be 5 min, and t2 can be 30-60 min. The adjustment period of the throttle valve can be 1 min. That is, if the evaporation temperature of the cooling indoor unit requires to be adjusted the controller acquires the evaporation temperature of the cooling indoor unit every 1 min to adjust the opening degree of EXV6 or EXV7.

In one embodiment, if the evaporation temperature of the cooling indoor unit requires to be adjusted, EXV3 is completely opened; in FIG. 1, ST4 is controlled to change direction to enable the first end to communicate with the second end; in FIG. 2, Sv3 is closed, and the controller also adjusts the opening degree of the first throttle valve EXV6 or the second throttle valve EXV7. As shown in FIG. 4, the initial opening degree of EXV6 or EXV7 is K which can be preset in advance according to practical situations; if the evaporation temperature of the indoor unit is less than or equal to T1 for t1, or anti-freezing protection starts in the indoor unit, then the controller reduces the opening degree of EXV6 or EXV7 by X; that is, the opening degree is K-X; when the opening degree of EXV6 or EXV7 is reduced, the pressure difference between the low pressure air tube L2 and the evaporator 211 would increase; the pressure of the low pressure air tube L2 is a fixed value, and therefore the evaporation pressure of the evaporator 211 would increase, and the evaporation temperature of the cooling indoor unit would be improved, and an indoor cooling requirement under a low temperature can be effectively satisfied, thus preventing the indoor unit from being frozen, and ensuring the reliability and comfort of the system. If the evaporation temperature of the cooling indoor unit is greater than T1 and anti-freezing protection does not start in the system within t3, then the opening degree of EXV6 or EXV7 is kept unchanged; and if the evaporation temperature of the cooling indoor unit is greater than T2 and anti-freezing protection does not start in the system within t3, then the controller increases the opening degree of EXV6 or EXV7 by X, that is the opening degree is K+X; when the opening degree of EXV6 or EXV7 is increased, the pressure difference between the low pressure air tube L2 and the evaporator 211 would be reduced; the pressure of the low pressure air tube L2 is a fixed value, and therefore the evaporation pressure of the evaporator 211 would be reduced. Therefore, the evaporation temperature of the cooling indoor unit would be reduced, and the phenomenon of blocking a refrigerant channel due to too high evaporation temperature can be avoided.

In summary, in the three-tube heat recovery multi-split air conditioning system according to the embodiment of the present disclosure, the controller is configured to acquire an evaporation temperature of the cooling indoor unit and an outdoor ambient temperature when the three-tube heat recovery multi-split air conditioning system operates in a cooling mode or a mixed operation mode, determine whether the evaporation temperature of the cooling indoor unit requires to be adjusted according to the evaporation temperature of the cooling indoor unit and the ambient temperature, and control the low temperature cooling and anti-freezing module to generate an intermediate pressure between the second end of the low temperature cooling and anti-freezing module and the low pressure air tube to adjust the evaporation temperature of the cooling indoor unit if the evaporation temperature of the indoor unit requires to be adjusted. Therefore, the system can adjust the evaporation temperature of the cooling indoor unit via the low temperature cooling and anti-freezing module, and an indoor cooling requirement under a low temperature can be effectively satisfied, thus preventing the indoor unit from being frozen, and ensuring the reliability and comfort of the system.

On the basis of the three-tube heat recovery multi-split air conditioning system, the present disclosure further provides a control method for the three-tube heat recovery multi-split air conditioning system.

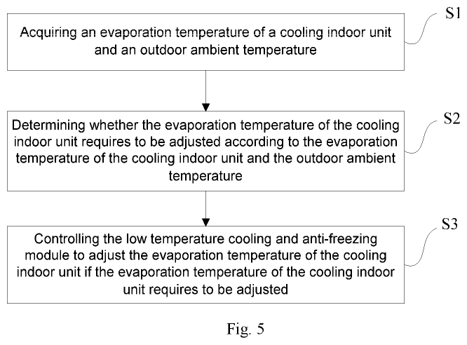

FIG. 5 is a flow chart of the control method for the three-tube heat recovery multi-split air conditioning system according to one embodiment of the present disclosure. As shown in FIG. 5, the method includes:

S1, acquiring an evaporation temperature of a cooling indoor unit and an outdoor ambient temperature;

The evaporation temperature of the cooling indoor unit and the outdoor ambient temperature can be acquired via corresponding temperature sensors.

S2, determining whether the evaporation temperature of the cooling indoor unit requires to be adjusted according to the evaporation temperature of the cooling indoor unit and the outdoor ambient temperature.

Further, determining whether the evaporation temperature of the cooling indoor unit requires to be adjusted according to the evaporation temperature of the cooling indoor unit and the outdoor ambient temperature, includes: determining that the evaporation temperature of the cooling indoor unit requires to be adjusted if the three-tube heat recovery multi-split air conditioning system has an indoor cooling requirement, the system operates in the cooling mode or the mixed operation mode, the evaporation temperature of the cooling indoor unit is less than or equal to a first preset temperature T1 for a first preset time t1, and the outdoor ambient temperature is less than or equal to a third preset temperature T3, the controller; and determining that the evaporation temperature of the cooling indoor unit does not require to be adjusted if the three-tube heat recovery multi-split air conditioning system operates in the heating mode, the outdoor ambient temperature is greater than the third preset temperature T3, or the evaporation temperature of the cooling indoor unit is greater than the first preset temperature T1 and anti-freezing protection does not start in the cooling indoor unit within the first preset time t1, and the third preset temperature T3 is greater than the first preset temperature T1. The first preset temperature T1, the third preset temperature T3 and the first preset time can be preset according to practical situations, for example, T1 can be 1° C., T3 can be 8° C., and t1 can be 5 min.

S3, controlling the low temperature cooling and anti-freezing module to adjust the evaporation temperature of the cooling indoor unit if the evaporation temperature of the cooling indoor unit requires to be adjusted.

In one embodiment, as shown in FIG. 1-2, the refrigerant distribution device is internally provided with a low temperature cooling and anti-freezing module; the module is disposed on the low pressure air tube; a first end of the module is in communication with the low pressure air tube; a second end of the module is disposed on the secondary heat exchange flow channel of the heat exchange assembly; and a third end of the module is disposed in front of the cooling-heating switching valve. When the three-tube heat recovery multi-split air conditioning system operates in the cooling mode or the mixed operation mode, an evaporation temperature of the cooling indoor unit and an outdoor ambient temperature are acquired; and whether the evaporation temperature of the cooling indoor unit requires to be adjusted is determined according to the evaporation temperature of the cooling indoor unit and the outdoor ambient temperature. As shown in FIG. 3, if the three-tube heat recovery multi-split air conditioning system operates in the cooling mode or the mixed operation mode, the evaporation temperature of the cooling indoor unit is less than or equal to 1° C., the outdoor ambient temperature is less than or equal to 8° C., and the duration reaches 5 min, then the controller can determine that the evaporation temperature of the cooling indoor unit requires to be adjusted. If the three-tube heat recovery multi-split air conditioning system operates in the heating mode, the outdoor ambient temperature is greater than 8° C., or the evaporation temperature of the cooling indoor unit is greater than 1° C. and anti-freezing protection does not start in the cooling indoor unit within 5 min, then the controller can determine that the evaporation temperature of the cooling indoor unit does not require to be adjusted. and in the three-tube heat recovery multi-split air conditioning system, if the temperature of the heat exchanger of the cooling indoor unit is lower than a temperature (generally −5° C.), then the cooling indoor unit will automatically start anti-freezing protection, to prevent the heat exchanger of the cooling indoor unit is frosted and frozen for a long time, which may damage the heat exchanger. The determination period can be 10-15 min. In other words, whether the evaporation temperature of the cooling indoor unit requires to be adjusted can be determined one time every 10-15 min.

If the evaporation temperature of the cooling indoor unit requires to be adjusted, the low temperature cooling and anti-freezing module is controlled to generate an intermediate pressure between the third end c of the low temperature cooling and anti-freezing module and the low pressure air tube; the evaporation temperature of the cooling indoor unit is positively correlated with pressure, and therefore, the evaporation temperature of the cooling indoor unit can be adjusted by adjusting a pressure difference between the third end c of the low temperature cooling and anti-freezing module and the low pressure air tube; for example, if the evaporation temperature is low, then the pressure difference between the third end c of the low temperature cooling and anti-freezing module and the low pressure air tube can be improved; the pressure on the low pressure air tube side keeps unchanged, and therefore, the improvement of the pressure difference can improve the pressure of the third end c of the low temperature cooling and anti-freezing module, and the evaporation pressure of the evaporator can be improved, and the evaporation temperature can be accordingly improved. The method can adjust the evaporation temperature of the cooling indoor unit via the cooling and anti-freezing module, and an indoor cooling requirement under a low temperature can be effectively satisfied, thus preventing the indoor unit from being frozen, and ensuring the reliability and comfort of the system.

According to one embodiment of the present disclosure, the method may further include: controlling the first end of the first four-way valve ST4 to communicate with the second end of the first four-way valve ST4 if the evaporation temperature of the cooling indoor unit does not require to be adjusted; and controlling the second end of the second four-way valve ST4 to communicate with the fourth end of the first four-way valve ST4 if the evaporation temperature of the cooling indoor unit requires to be adjusted.

In one embodiment, as shown in FIG. 1, if the evaporation temperature of the cooling indoor unit does not require to be adjusted, the first end of ST4 is controlled to communicate with the second end of ST4; EXV6 is controlled to completely open; and the low temperature cooling and anti-freezing module 33 does not operate at all. The high temperature high pressure refrigerant discharged by the compressor is delivered to the condenser 212 for condensation via the high pressure air tube L3 and Svb; the generated low temperature high pressure liquid refrigerant is returned to the refrigerant distribution device 3; a part of the liquid refrigerant is delivered to the evaporator 211 for evaporation, and the generated low pressure steam is returned to the outdoor unit 1 via Sva, ST4 and the low pressure air tube L2; a part of the liquid refrigerant is returned to the outdoor unit 1 via the high pressure liquid tube L1, is throttled by EXV1 and EXV2, is evaporated in the outdoor heat exchanger to be a gaseous refrigerant, converges with the low pressure gaseous refrigerant returned from the low pressure air tube, and finally is returned to the suction end of the compressor 11;

If the evaporation temperature of the cooling indoor unit requires to be adjusted, EXV3 is completely opened, and ST4 is controlled to change direction to enable the second end to communicate with the fourth end; the high temperature high pressure refrigerant discharged by the compressor 11 is delivered to the condenser 212 for condensation via the high pressure air tube L3 and Svb; the generated low temperature high pressure liquid refrigerant is returned to the refrigerant distribution device 3; the other part of the liquid refrigerant is returned to the outdoor unit 1 via the high pressure liquid tube L1, is throttled by EXV1 and EXV2, is evaporated in the outdoor heat exchanger to be a gaseous refrigerant, converges with the low pressure gaseous refrigerant returned from the low pressure air tube, and finally is returned to the suction end of the compressor 11. the other part is throttled by EXV4 to be an intermediate pressure liquid refrigerant; the intermediate pressure liquid refrigerant is evaporated by the evaporator 211; the generated intermediate pressure gaseous refrigerant is throttled by ST4 and EXV6, then flows to the second heat exchange flow channel L5 of the heat exchange assembly 31 and the low pressure air tube L2, and is finally returned to the outdoor unit 1. It can be understood that if the evaporation temperature of the cooling indoor unit requires to be adjusted, the throttling of EXV6 can generate an intermediate pressure between EXV6 and the low pressure air tube L2; the pressure difference between EXV6 and the low pressure air tube L2 can be changed by changing the opening degree of EXV6, and the evaporation temperature of the cooling indoor unit can be changed to effectively satisfy the indoor cooling requirement under a low temperature, thus preventing the indoor unit from being frozen, and ensuring the reliability and comfort of the system.

According to another embodiment of the present disclosure, the method may further include: controlling the third electromagnetic valve Sv3 to open if the evaporation temperature of the cooling indoor unit does not require to be adjusted; and controlling the third electromagnetic valve Sv3 to close if the evaporation temperature of the cooling indoor unit requires to be adjusted.

In one embodiment, as shown in FIG. 2, the flow direction of the one-way valve D is as shown by the arrow in FIG. 2; if the evaporation temperature of the cooling indoor unit does not require to be adjusted, Sv3 is controlled to open; EXV7 is controlled to completely open; and the low temperature cooling and anti-freezing module 33 does not operate at all. The high temperature high pressure refrigerant discharged by the compressor 11 is delivered to the condenser 212 for condensation via the high pressure air tube L3 and Svb; the generated low temperature high pressure liquid refrigerant is returned to the refrigerant distribution device 3; a part of the liquid refrigerant is delivered to the evaporator 211 for evaporation, and the generated low pressure steam is returned to the outdoor unit 1 via Sva, Sv3 and the low pressure air tube L2; the other part of the liquid refrigerant is returned to the outdoor unit 1 via the high pressure liquid tube L1, is throttled by EXV1 and EXV2, is evaporated in the outdoor heat exchanger to be a gaseous refrigerant, converges with the low pressure gaseous refrigerant returned from the low pressure air tube, and finally is returned to the suction end of the compressor 11.

If the evaporation temperature of the cooling indoor unit requires to be adjusted, EXV3 is completely opened, and Sv3 is controlled to close; the high temperature high pressure refrigerant discharged by the compressor 11 is delivered to the condenser 212 for condensation via the high pressure air tube L3 and Svb; the generated low temperature high pressure liquid refrigerant is returned to the refrigerant distribution device 3; the other part of the liquid refrigerant is returned to the outdoor unit 1 via the high pressure liquid tube L1, is throttled by EXV1 and EXV2, is evaporated in the outdoor heat exchanger to be a gaseous refrigerant, converges with the low pressure gaseous refrigerant returned from the low pressure air tube, and finally is returned to the suction end of the compressor 11. the other part is throttled by EXV4 to be an intermediate pressure liquid refrigerant; the intermediate pressure liquid refrigerant is evaporated by the evaporator 211; the generated intermediate pressure gaseous refrigerant is throttled by the one-way valve D and EXV7, then flows to the second heat exchange flow channel L5 of the heat exchange assembly 31 and the low pressure air tube L2, and is finally returned to the outdoor unit 1. It can be understood that if the evaporation temperature of the cooling indoor unit requires to be adjusted, the throttling of EXV7 can generate an intermediate pressure between EXV7 and the low pressure air tube L2; the pressure difference between EXV7 and the low pressure air tube L2 can be changed by changing the opening degree of EXV7, and the evaporation temperature of the cooling indoor unit can be changed to effectively satisfy the indoor cooling requirement under a low temperature, thus preventing the indoor unit from being frozen, and ensuring the reliability and comfort of the system.

According to one embodiment of the present disclosure, the method further include: acquiring an evaporation temperature of the cooling indoor unit if the evaporation temperature of the cooling indoor unit requires to be adjusted; reducing an opening degree of the first throttle valve EXV6 by a first preset opening degree X if the evaporation temperature of the cooling indoor unit is less than or equal to the first preset temperature T1 for the first preset time t1, or anti-freezing protection starts in the indoor unit; keeping the opening degree of the first throttle valve EXV6 unchanged if the evaporation temperature of the cooling indoor unit is greater than the first preset temperature T1 and anti-freezing protection does not start in the indoor unit; and increasing the opening degree of the first throttle valve EXV6 by the first preset opening degree X if the evaporation temperature of the cooling indoor unit is greater than a second preset temperature T2 and anti-freezing protection does not start in the indoor unit within a second preset time t2, and the first preset temperature T1 is less than the second preset temperature T2.

According to one embodiment of the present disclosure, in the system as shown in FIG. 2, the controller is further configured to: acquire an evaporation temperature of the cooling indoor unit if the evaporation temperature of the cooling indoor unit requires to be adjusted; reduce an opening degree of the second throttle valve EXV7 by the first preset opening degree X if the evaporation temperature of the cooling indoor unit is less than or equal to the first preset temperature T1 for the first preset time t1, or anti-freezing protection starts in the indoor unit; keep the opening degree of the second throttle valve EXV7 unchanged if the evaporation temperature of the cooling indoor unit is greater than the first preset temperature T1 and anti-freezing protection does not start in the indoor unit; and increase the opening degree of the second throttle valve EXV7 by the first preset opening degree X if the evaporation temperature of the cooling indoor unit is greater than the second preset temperature T2 and anti-freezing protection does not start in the indoor unit within the second preset time t2. The first preset opening degree X can be preset according to practical situations.

In the present disclosure, the first preset temperature T1, the second preset temperature T2, the first preset time t1 and the second preset time t2 can be preset according to practical situations, for example, T1 can be 1° C., T2 can be 12° C., t1 can be 5 min, and t2 can be 30-60 min. The adjustment period of the throttle valve can be 1 min. That is, if the evaporation temperature of the cooling indoor unit requires to be adjusted the controller acquires the evaporation temperature of the cooling indoor unit every 1 min to adjust the opening degree of EXV6 or EXV7.

In one embodiment, if the evaporation temperature of the cooling indoor unit requires to be adjusted, EXV3 is completely opened; in FIG. 1, ST4 is controlled to change direction to enable the first end to communicate with the second end; in FIG. 2, Sv3 is closed, and the opening degree of the first throttle valve EXV6 or the second throttle valve EXV7 is also adjusted. As shown in FIG. 4, the initial opening degree of EXV6 or EXV7 is K which can be preset in advance according to practical situations; if the evaporation temperature of the indoor unit is less than or equal to T1 for t1, or anti-freezing protection starts in the indoor unit, then the controller reduces the opening degree of EXV6 or EXV7 by X; that is, the opening degree is K-X; when the opening degree of EXV6 or EXV7 is reduced, the pressure difference between the low pressure air tube L2 and the evaporator 211 would increase; the pressure of the low pressure air tube L2 is a fixed value, and therefore the evaporation pressure of the evaporator 211 would increase, and the evaporation temperature of the cooling indoor unit would be improved, and an indoor cooling requirement under a low temperature can be effectively satisfied, thus preventing the indoor unit from being frozen, and ensuring the reliability and comfort of the system. If the evaporation temperature of the cooling indoor unit is greater than T1 and anti-freezing protection does not start in the indoor unit, then the opening degree of EXV6 or EXV7 is kept unchanged; and if the evaporation temperature of the cooling indoor unit is greater than T2 and anti-freezing protection does not start in the system within t3, then the opening degree of EXV6 or EXV7 would be increased by X, that is the opening degree is K+X; when the opening degree of EXV6 or EXV7 is increased, the pressure difference between the low pressure air tube L2 and the evaporator 211 would be reduced; the pressure of the low pressure air tube L2 is a fixed value, and therefore the evaporation pressure of the evaporator 211 would be reduced. Therefore, the evaporation temperature of the cooling indoor unit would be reduced, and the phenomenon of blocking a refrigerant channel due to too high evaporation temperature can be avoided.

In the control method for the three-tube heat recovery multi-split air conditioning system according to the embodiment of the present disclosure, first, an evaporation temperature of the cooling indoor unit and an outdoor ambient temperature are acquired; then, whether the evaporation temperature of the cooling indoor unit requires to be adjusted is determined according to the evaporation temperature of the cooling indoor unit and the outdoor ambient temperature; and if the evaporation temperature of the cooling indoor unit requires to be adjusted, then the low temperature cooling and anti-freezing module is controlled to generate an intermediate pressure between the second end of the low temperature cooling and anti-freezing module and the low pressure air tube to adjust the evaporation temperature of the cooling indoor unit. Therefore, the method can adjust the evaporation temperature of the cooling indoor unit via the low temperature cooling and anti-freezing module, and an indoor cooling requirement under a low temperature can be effectively satisfied, thus preventing the indoor unit from being frozen, and ensuring the reliability and comfort of the system.

In addition, the present disclosure further provides a non-transitory computer readable storage medium having stored therein a computer program that, when executed by a processor, causes the processor to realize the control method.

In the non-transitory computer readable storage medium according to the embodiment of the present disclosure, first, an evaporation temperature of the cooling indoor unit and an outdoor ambient temperature are acquired; then, whether the evaporation temperature of the cooling indoor unit requires to be adjusted is determined according to the evaporation temperature of the cooling indoor unit and the outdoor ambient temperature; and if the evaporation temperature of the cooling indoor unit requires to be adjusted, then the low temperature cooling and anti-freezing module is controlled to generate an intermediate pressure between the second end of the low temperature cooling and anti-freezing module and the low pressure air tube to adjust the evaporation temperature of the cooling indoor unit, and an indoor cooling requirement under a low temperature can be effectively satisfied, thus preventing the indoor unit from being frozen, and ensuring the reliability and comfort of the system.

In the descriptions of the present disclosure, it should be understood that the azimuth or position relationships indicated by the terms “center”, “longitudinal”, “transverse”, “length”, “width”, “thickness”, “upper”, “lower”, “front”, “back”, “left”, “right”, “vertical”, “horizontal”, “top”, “bottom”, “inside”, “outside”, “clockwise”, “anticlockwise”, “axial direction”, “radial direction”, “circumferential” and the like are on the basis of the azimuth and position relationships as shown in the drawings, and are only intended to facilitate and simplify the description of the present disclosure, but not intended to indicate or imply that the designated devices or elements may have a specific azimuth or are constructed and operated in a specific azimuth. Therefore, the terms should not be considered to limit the present disclosure.

In addition, the terms “first” and “second” are used for the purpose of description only, but should not be considered to indicate or imply relative importance or implicitly indicate the number of the indicated features. Therefore, a feature defined by “first” or “second” may explicitly or implicitly include one or more the features. In the description of the present disclosure, unless otherwise stated, “a plurality of” means two or more.

In the present disclosure, unless otherwise specified and stated, the terms “mount”, “connect”, “connection”, “fix” and the like should be understood in a broad sense, for example, the term “connection” can be a fixed connection, a detachable connection, or an integral connection, can be a mechanical connection, or an electrical connection, and can be a direct connection, an indirect connection via an intermediate medium, an internal communication between two elements, or an interaction relationship between two elements.

In the present disclosure, unless otherwise specified and stated, a first feature being “on” or “under” a second feature means that the first feature and the second feature can be in direct contact, or in indirect contact via an intermediate medium. Furthermore, the first feature being “on”, “above” and “over” the second feature means that the first feature can be right above or obliquely above the second feature, or only denotes that the horizontal height of the first feature is greater than that of the second feature. The first feature being “under”, “below” and “underneath” the second feature means that the first feature can be right below or obliquely below the second feature, or only denotes that the horizontal height of the first feature is less than that of the second feature.

In the description of the specification, the reference terms “one embodiment”, “some embodiments”, “example”, “a specific example” or “some examples” and the like mean that the specific characteristic, structure, material or feature described in combination with the embodiment or the example are contained in at least one embodiment or example of the present disclosure. In the specification, the schematic recitation of the above-described terms does not necessarily refer to the same embodiment or example. Furthermore, the described specific characteristic, structure, material or feature can be combined in an appropriate manner in any one or more embodiments or examples.

1. A three-tube heat recovery multi-split air conditioning system, comprising:
an outdoor unit and an indoor unit, wherein the outdoor unit comprises at least one compressor, a low pressure liquid storage tank, and an outdoor heat exchanger; the indoor unit comprises an indoor heat exchanger; an exhaust end of the compressor is connected to the outdoor heat exchanger and the indoor heat exchanger respectively; a suction end of the compressor is connected to a first end of the low pressure liquid storage tank; and a second end of the low pressure liquid storage tank is connected to the outdoor heat exchanger;
a refrigerant distribution device, having one side connected to the outdoor unit via a high pressure liquid tube, a low pressure air tube and a high pressure air tube, and a second side connected to the indoor unit, and comprising a heat exchange assemble, a cooling-heating switching valve, and a low temperature cooling and anti-freezing module, wherein a heat exchange assembly comprises a first flow channel and a second heat exchange flow channel; a first end of the low temperature cooling and anti-freezing module is connected to the low pressure air tube; a second end of the low temperature cooling and anti-freezing module is connected to the second heat exchange flow channel of the heat exchange assembly; and a third end of the low temperature cooling and anti-freezing module is connected to the cooling-heating switching valve; and
a controller, configured to:
acquire an evaporation temperature of a cooling indoor unit and an outdoor ambient temperature;
determine whether the evaporation temperature of the cooling indoor unit requires to be adjusted according to the evaporation temperature of the cooling indoor unit and the outdoor ambient temperature; and
control the low temperature cooling and anti-freezing module to adjust the evaporation temperature of the cooling indoor unit.

2. The three-tube heat recovery multi-split air conditioning system according to claim 1, wherein a first end of a first heat exchange flow channel is connected to the outdoor heat exchanger via the high pressure liquid tube, and the second end of the first heat exchange flow channel is connected to the indoor unit; a first end of the second heat exchange flow channel is connected to the low pressure liquid storage tank via the low pressure air tube, and the second end of the second heat exchange flow channel is connected to the second end of the first heat exchange flow channel.

3. The three-tube heat recovery multi-split air conditioning system according to claim 2, wherein the indoor heat exchanger comprises an evaporator and a condenser; the refrigerant distribution device comprises at least one cooling-heating switching valve; each cooling-heating switching valve comprises a first electromagnetic valve and a second electromagnetic valve; a first end of the first electromagnetic valve is connected to the third end of the low temperature cooling and anti-freezing module; a first end of the second electromagnetic valve is connected to the high pressure air tube; and the second end of the first electromagnetic valve and the second end of the second electromagnetic valve in each cooling-heating switching valve are correspondingly connected to the evaporator or the condenser.

4. The three-tube heat recovery multi-split air conditioning system according to claim 3, wherein the low temperature cooling and anti-freezing module comprises:
a first four-way valve, having a first end connected to the low pressure air tube, a second end connected to the first end of the first electromagnetic valve, and a third end connected to the low pressure air tube via a capillary tube; and
a first throttle valve, having a first end connected to a fourth end of the first four-way valve, and the second end connected to the second heat exchange flow channel of the heat exchange assembly.

5. The three-tube heat recovery multi-split air conditioning system according to claim 3, wherein the low temperature cooling and anti-freezing module comprises:
a third electromagnetic valve, having a first end connected to the low pressure air tube, and a second end connected to the first end of the first electromagnetic valve;
a one-way valve, having a first end connected to the second end of the third electromagnetic valve; and
a second throttle valve, having a first end connected to a second end of the one-way valve, and the second end connected to the second heat exchange flow channel of the heat exchange assembly.

6. The three-tube heat recovery multi-split air conditioning system according to claim 4, wherein the controller is further configured to:
control the first end of the first four-way valve to communicate with the second end of the first four-way valve if the evaporation temperature of the cooling indoor unit does not require to be adjusted; and
control the second end of the first four-way valve to communicate with the fourth end of the first four-way valve if the evaporation temperature of the cooling indoor unit requires to be adjusted.

7. The three-tube heat recovery multi-split air conditioning system according to claim 5, wherein the controller is further configured to:
control the third electromagnetic valve to open if the evaporation temperature of the cooling indoor unit does not require to be adjusted; and
control the third electromagnetic valve to close if the evaporation temperature of the cooling indoor unit requires to be adjusted.

8. The three-tube heat recovery multi-split air conditioning system according to claim 6, wherein the controller is configured to:
acquire an evaporation temperature of the cooling indoor unit if the evaporation temperature of the cooling indoor unit requires to be adjusted,
reduce an opening degree of the first throttle valve by a first preset opening degree when the evaporation temperature of the cooling indoor unit is less than or equal to a first preset temperature for a first preset time, or anti-freezing protection starts in the cooling indoor unit;
keep the opening degree of the first throttle valve unchanged when the evaporation temperature of the cooling indoor unit is greater than the first preset temperature and anti-freezing protection does not start in the cooling indoor unit; and
increase the opening degree of the first throttle valve by the first preset opening degree when the evaporation temperature of the cooling indoor unit is greater than a second preset temperature and anti-freezing protection does not start in the cooling indoor unit within a second preset time,
wherein the first preset temperature is less than the second preset temperature.

9. The three-tube heat recovery multi-split air conditioning system according to claim 7, wherein the controller is configure to:
acquire an evaporation temperature of the cooling indoor unit if the evaporation temperature of the cooling indoor unit requires to be adjusted,
reduce an opening degree of the second throttle valve by a first preset opening degree when the evaporation temperature of the cooling indoor unit is less than or equal to a first preset temperature for a first preset time, or anti-freezing protection starts in the cooling indoor unit;
keep the opening degree of the second throttle valve unchanged when the evaporation temperature of the cooling indoor unit is greater than the first preset temperature and anti-freezing protection does not start in the cooling indoor unit; and
increase the opening degree of the second throttle valve by the first preset opening when the evaporation temperature of the cooling indoor unit is greater than a second preset temperature and anti-freezing protection does not start in the cooling indoor unit within a second preset time.

10. The three-tube heat recovery multi-split air conditioning system according to claim 1, wherein the controller is configured to:
determine that the evaporation temperature of the cooling indoor unit requires to be adjusted when the three-tube heat recovery multi-split air conditioning system has an indoor cooling requirement, the system operates in a cooling mode or a mixed operation mode, the evaporation temperature of the cooling indoor unit is less than or equal to a first preset temperature for a first preset time, and the outdoor ambient temperature is less than or equal to a third preset temperature; and
determine that the evaporation temperature of the cooling indoor unit does not require to be adjusted when the three-tube heat recovery multi-split air conditioning system operates in a heating mode, the outdoor ambient temperature is greater than the third preset temperature, or the evaporation temperature of the cooling indoor unit is greater than the first preset temperature and anti-freezing protection does not start in the cooling indoor unit within a first preset time,
wherein the third preset temperature is greater than the first preset temperature.

11. A control method for the three-tube heat recovery multi-split air conditioning system according to a three-tube heat recovery multi-split air conditioning system, comprising:
an outdoor unit and an indoor unit, wherein the outdoor unit comprises at least one compressor, a low pressure liquid storage tank, and an outdoor heat exchanger; the indoor unit comprises an indoor heat exchanger; an exhaust end of the compressor is connected to the outdoor heat exchanger and the indoor heat exchanger respectively; a suction end of the compressor is connected to a first end of the low pressure liquid storage tank; and a second end of the low pressure liquid storage tank is connected to the outdoor heat exchanger;
a refrigerant distribution device, having one side connected to the outdoor unit via a high pressure liquid tube, a low pressure air tube and a high pressure air tube, and a second side connected to the indoor unit, and comprising a heat exchange assemble, a cooling-heating switching valve, and a low temperature cooling and anti-freezing module, wherein a heat exchange assembly comprises a first flow channel and a second heat exchange flow channel; a first end of the low temperature cooling and anti-freezing module is connected to the low pressure air tube; a second end of the low temperature cooling and anti-freezing module is connected to the second heat exchange flow channel of the heat exchange assembly; and a third end of the low temperature cooling and anti-freezing module is connected to the cooling-heating switching valve; and
a controller, configured to:
acquire an evaporation temperature of a cooling indoor unit and an outdoor ambient temperature;
determine whether the evaporation temperature of the cooling indoor unit requires to be adjusted according to the evaporation temperature of the cooling indoor unit and the outdoor ambient temperature; and
control the low temperature cooling and anti-freezing module to adjust the evaporation temperature of the cooling indoor unit, further comprising:
acquiring an evaporation temperature of a cooling indoor unit and an outdoor ambient temperature;
determining whether the evaporation temperature of the cooling indoor unit requires to be adjusted according to the evaporation temperature of the cooling indoor unit and the outdoor ambient temperature; and
controlling the low temperature cooling and anti-freezing module to adjust the evaporation temperature of the cooling indoor unit.

12. The control method according to claim 11, further comprising:
controlling a first end of a first four-way valve to communicate with a second end of the first four-way valve if the evaporation temperature of the cooling indoor unit does not require to be adjusted; and
controlling a second end of a first four-way valve to communicate with a fourth end of the first four-way valve if the evaporation temperature of the cooling indoor unit requires to be adjusted.

13. The control method according to claim 11, further comprising:
controlling a third electromagnetic valve to open if the evaporation temperature of the cooling indoor unit does not require to be adjusted; and
controlling the third electromagnetic valve to close if the evaporation temperature of the cooling indoor unit requires to be adjusted.

14. The control method according to claim 12, further comprising:
acquiring an evaporation temperature of the cooling indoor unit if the evaporation temperature of the cooling indoor unit requires to be adjusted;
reducing an opening degree of a first throttle valve by a first preset opening degree when the evaporation temperature of the cooling indoor unit is less than or equal to a first preset temperature for a first preset time, or anti-freezing protection starts in the cooling indoor unit;
keeping the opening degree of the first throttle valve unchanged when the evaporation temperature of the cooling indoor unit is greater than the first preset temperature and anti-freezing protection does not start in the cooling indoor unit; and
increasing the opening degree of the first throttle valve by the first preset opening degree when the evaporation temperature of the cooling indoor unit is greater than a second preset temperature and anti-freezing protection does not start in the cooling indoor unit within a second preset time,
wherein the first preset temperature is less than the second preset temperature.

15. The control method according to claim 13, further comprising:
acquiring an evaporation temperature of the cooling indoor unit if the evaporation temperature of the cooling indoor unit requires to be adjusted;
reducing an opening degree of a second throttle valve by a first preset opening degree when the evaporation temperature of the cooling indoor unit is less than or equal to a first preset temperature for a first preset time, or anti-freezing protection starts in the cooling indoor unit;
keeping the opening degree of the second throttle valve unchanged when the evaporation temperature of the cooling indoor unit is greater than the first preset temperature and anti-freezing protection does not start in the cooling indoor unit; and
increasing the opening degree of the second throttle valve by the first preset opening degree when the evaporation temperature of the cooling indoor unit is greater than a second preset temperature and anti-freezing protection does not start in the cooling indoor unit within a second preset time.

16. The control method according to claim 11, further comprising:
determining that the evaporation temperature of the cooling indoor unit requires to be adjusted when the three-tube heat recovery multi-split air conditioning system operates in a cooling mode or a mixed operation mode, the evaporation temperature of the indoor unit is less than or equal to a first preset temperature for a first preset time, and the outdoor ambient temperature is less than or equal to a third preset temperature; and
determining that the evaporation temperature of the cooling indoor unit does not require to be adjusted when the three-tube heat recovery multi-split air conditioning system operates in a heating mode, the outdoor ambient temperature is greater than the third preset temperature, or the evaporation temperature of the indoor unit is greater than the first preset temperature and anti-freezing protection does not start in the indoor unit within a first preset time,
wherein the third preset temperature is greater than the first preset temperature.

17. A non-transitory computer readable storage medium having stored therein a computer program that, when executed by a processor, causes the processor to perform a control method for the three-tube heat recovery multi-split air conditioning system, comprising:
an outdoor unit and an indoor unit, wherein the outdoor unit comprises at least one compressor, a low pressure liquid storage tank, and an outdoor heat exchanger; the indoor unit comprises an indoor heat exchanger; an exhaust end of the compressor is connected to the outdoor heat exchanger and the indoor heat exchanger respectively; a suction end of the compressor is connected to a first end of the low pressure liquid storage tank; and a second end of the low pressure liquid storage tank is connected to the outdoor heat exchanger;
a refrigerant distribution device, having one side connected to the outdoor unit via a high pressure liquid tube, a low pressure air tube and a high pressure air tube, and a second side connected to the indoor unit, and comprising a heat exchange assemble, a cooling-heating switching valve, and a low temperature cooling and anti-freezing module, wherein a heat exchange assembly comprises a first flow channel and a second heat exchange flow channel; a first end of the low temperature cooling and anti-freezing module is connected to the low pressure air tube; a second end of the low temperature cooling and anti-freezing module is connected to the second heat exchange flow channel of the heat exchange assembly; and a third end of the low temperature cooling and anti-freezing module is connected to the cooling-heating switching valve; and
a controller, configured to:
acquire an evaporation temperature of a cooling indoor unit and an outdoor ambient temperature;
determine whether the evaporation temperature of the cooling indoor unit requires to be adjusted according to the evaporation temperature of the cooling indoor unit and the outdoor ambient temperature; and
control the low temperature cooling and anti-freezing module to adjust the evaporation temperature of the cooling indoor unit, further comprising:
acquiring an evaporation temperature of a cooling indoor unit and an outdoor ambient temperature;
determining whether the evaporation temperature of the cooling indoor unit requires to be adjusted according to the evaporation temperature of the cooling indoor unit and the outdoor ambient temperature; and
controlling the low temperature cooling and anti-freezing module to adjust the evaporation temperature of the cooling indoor unit.
